(19) United States
(12) Patent Application Publication
(10) Pub. No.: US 2021/0092194 A1
(43) Pub. Date: Mar. 25, 2021

(54) SYSTEM AND METHOD OF INTERNET OF THINGS FOR PUSHING MESSAGE

(71) Applicant: HEIMAVISTA INC., Taipei City (TW)

(72) Inventor: Ching-Kang Lee, Taipei City (TW)

(21) Appl. No.: 16/579,447

(22) Filed: Sep. 23, 2019

(51) Int. Cl. H04L 29/08; H04W 4/80

(52) U.S. Cl. CPC H04L 67/26; H04L 67/146; H04L 67/34; H04W 4/80

(57) ABSTRACT

The invention provides a system and method of Internet of Things for pushing message, which comprises a remote server, at least one hardware device, and an electronic communication device. The remote server stores at least one subject name and a plurality of startup codes corresponding to the subject name. Each of hardware devices is configured with a startup code. The electronic communication device transmits the startup code of the hardware device to the remote server when the hardware device is started for the first time. Then, the remote server determines the subject name corresponding to the startup code of the hardware device after receiving the startup code of the hardware device, and pushes at least one message related to the determined subject name to the electronic communication device.

### FIELD OF THE INVENTION

The invention relates to a system and method for pushing message, and more particular to a system and method of Internet of Things for pushing message.

### BACKGROUND

Internet of things technology is the focus of science and technology development in the new generation. Many manufacturers are actively investing in related research and product development. The internet of things system usually comprises an electronic communication device and a hardware device. The electronic communication device is able to install an application program (APP) capable of controlling the operation of the hardware device. The electronic communication device can establish a wireless communication connection between the electronic communication device and the hardware device by the application program. After the wireless communication connection is established, the electronic communication device may perform related settings to the hardware device or control the actions of the hardware device by the interface operation of the application program.

Furthermore, when the electronic communication device starts the hardware device at first time by the APP program, it needs to wait for a verification time of startup of the hardware device. Alternative, when the electronic communication device establishes a wireless communication connection with the hardware device by the use of the application program, it needs to wait for a connection time so that the wireless communication connection can be successfully established. While waiting for the verification time of startup or the connection time, the user of the electronic communication device can usually have no choice but to watch the connection frame on the screen of the electronic communication device.

For the above reason, the present invention provides a means of Internet of Things for pushing message, in which can push at least one message to the electronic communication device and display the message on the operation interface of the application program of the electronic communication device during the verification process of startup of the hardware device, or during the establishment of a wireless communication connection between the electronic communication device and the hardware device, so that the user of the electronic communication device can watch at least one pushed message before waiting for the verification process of startup of the hardware device to be completed or before waiting for the wireless communication connection process to be completed, which will be the objective of this invention.

### SUMMARY

It is one objective of the present invention to provide a system of Internet of Things for pushing message, which comprises at least one hardware device, an electronic communication device, and a remote server. The remote server stores at least one subject name and a plurality of startup codes corresponding to the subject name. The electronic communication device includes an application program, and each of hardware devices is configured with one of the startup codes. The electronic communication device is communicated with the hardware device in a way of short distance wireless communication connection. When the hardware device is started for the first time, the electronic communication device uploads the startup code of the hardware device to the remote server, and then the remote server determines the subject name corresponding to the startup code of the hardware device, and then pushes the message related to the determined subject name to the electronic communication device. Thereby, the user of the electronic communication device can watch an advertisement or notification message pushed by the remote server while wait for the execution of the verifying procedure of the hardware device.

It is another objective of the present invention to provide a system of Internet of Things for pushing message, in which the remote server transmits a firmware software including a message to the electronic communication device when the remote server wants to perform a firmware update process for the hardware device. The application program of the electronic communication device updates the firmware of the hardware device by the firmware software, and configures the message included in the firmware software into the firmware. When the application program of the electronic communication device controls the operation of the hardware device that has performed the firmware update, the message in the firmware will be displayed on the operation interface of the application of the electronic communication device. Thus, the advertisement or notification message 136 can be still pushed to the electronic communication device 40 via the hardware device 30 even if the electronic communication device is disconnected from the remote server.

It is another objective of the present invention to provide a system of Internet of Things for pushing message, in which the hardware device is configured with a unique identification code. The electronic communication device will transmit the unique identification code to the remote server when the application program of the electronic communication device is performing the wireless communication connection process. The remote server determines the subject name corresponding to the unique identification code of the hardware device, and pushes at least one corresponding message related to the determined subject name to the electronic communication device. Thereby, the user of the electronic communication device can watch the advertisement or notification message pushed by the remote server before waiting for a wireless communication connection process between the electronic communication device and the hardware device to be completed.

It is another objective of the present invention to provide a system of Internet of Things for pushing message, in which a plurality of messages may be configured into the hardware device in advance. The user of the electronic communication device inputs a startup code into the electronic communication device when the hardware device is started for the first time. Afterwards, the hardware device will push the message to the electronic communication device by the way of short distance communication connection according to the inputted startup code when the application program of the electronic communication device controls the operation of the hardware device.

The present invention provides a system of Internet of Things for pushing message, comprising: a remote server comprising a database and a graphical program interface, the database connected to the graphical program interface, wherein the graphical program interface comprises a subject input box and a startup code generator, the startup code generator generates a plurality of startup codes according to a subject name inputted into the subject input box, the subject name and the startup codes corresponding to the subject name are stored in the database; at least one hardware device comprising a microcontroller and a first short distance communication module, wherein the microcontroller is electrically connected to the first short distance communication module, and each of the hardware devices is configured with one of the startup codes; and at least one electronic communication device comprising a processor, a second short distance communication module, a network communication module, a storage module, and a display unit, wherein the processor is electrically connected to the second short distance communication module, the network communication module, the storage module, and the display unit, the storage module stores an application program for operating the hardware device, the electronic communication device communicates with the hardware device via the first short distance communication module and the second short distance communication module, and an operation interface of the application program is displayed on the display unit when the application program starts; wherein the application program of the electronic communication device uploads the startup code of the hardware device to the remote server when the hardware device is started for the first time, the remote server determines the subject name corresponding to the startup code of the hardware device after receiving the startup code of the hardware device, and pushes at least one message related to the determined subject name to the electronic communication device, so that the message pushed by the remote server is able to display on the operation interface of the application program of the electronic communication device.

In one embodiment of the present invention, further comprises a management device having a function for connecting network, the management device is communicated with the remote server, and comprises an input interface; when the management device logs into the remote server, a user of the management device inputs the subject name into the subject input box of the graphical program interface by the input interface, and inputs the number of the startup codes to be generated into the startup code generator of the graphical program interface by the input interface so that the plurality of the startup codes corresponding to the subject name can be obtained by the management device, and then each of the hardware devices is configured with one of the startup codes by the management device.

In one embodiment of the present invention, the message related to the subject name is uploaded to the remote server by the management device, and stored s in the database of the remote server.

In one embodiment of the present invention, the subject name is a business name, a merchant name, a brand name or an event name.

In one embodiment of the present invention, the message is an advertisement message or a notification message.

In one embodiment of the present invention, the message is a message of text format, sound format or video format.

In one embodiment of the present invention, the hardware device comprises a firmware configured with the message, the message of the firmware is displayed on the operation interface of the application program of the electronic communication device when the electronic communication device controls the operation of the hardware device by the application program.

In one embodiment of the present invention, the remote server determines the subject name corresponding to the startup code of the hardware device after receiving the startup code of the hardware device, selects at least one the message related to the determined subject name, and configures the selected message into a firmware software; wherein the remote server transmits the firmware software including the message to the electronic communication device when the remote server wants to perform a firmware update process for the hardware device; the application program of the electronic communication device updates the firmware of the hardware device by the received firmware software, and configures the message included in the firmware software into the firmware; afterwards, the message in the firmware is displayed on the operation interface of the application program of the electronic communication device when the electronic communication device controls the operation of the hardware device.

In one embodiment of the present invention, the hardware device is further configured with a unique identification code, the application program of the electronic communication device uploads the startup code and the unique identification code of the hardware device to the remote server when the hardware device is started for the first time, the remote server records the unique identification code of the hardware device, and maps the startup code and the unique identification code of the hardware device to the same subject name; the electronic communication device transmits the unique identification code of the hardware device to the remote server whenever the application program of the electronic communication device executes a short distance wireless communication connection process between the electronic communication device and the hardware device, the remote server determines the subject name corresponding to the unique identification code of the hardware device, and pushes at least one the message related to the determined subject name to the electronic communication device so that the message pushed by the remote server is able to display on the operation interface of the application program of the electronic communication device.

In one embodiment of the present invention, the remote server determines the subject name corresponding to the unique identification code of the hardware device after receiving the unique identification code of the hardware device, selects at least one the message related to the determined subject name, and configures the selected message into a firmware software; wherein the remote server transmits the firmware software including the message to the electronic communication device when the remote server performs a firmware update process for the hardware device, the application program of the electronic communication device updates the firmware of the hardware device by the received firmware software, and configures the message included in the firmware software into the firmware; afterwards, the message in the firmware is displayed on the operation interface of the application program of the electronic communication device when the electronic communication device controls the operation of the hardware device.

The present invention further provides a system of Internet of Things for pushing message, comprising: at least one hardware device storing a firmware and comprising a microcontroller and a first short distance communication module, wherein the microcontroller is electrically connected to the first short distance communication module, a plurality of startup codes and a plurality of messages are defined in the firmware, and each of the startup code is corresponding to at least one the message; and at least one electronic communication device comprising a processor, a second short distance communication module, a storage module, and a display unit, wherein the processor is electrically connected to the second short distance communication module, the storage module and the display unit, the storage module stores an application program for operating the hardware device, the electronic communication device communicates with the hardware device via the first short distance communication module and the second short distance communication module, and an operation interface of the application program is displayed on the display unit when the application program starts; wherein one of the startup codes is inputted into the operation interface of the application program of the electronic communication device, and is transmitted to the hardware device via the second short distance communication module and the first short distance communication module, the microcontroller of the hardware device determines the message corresponding to the received startup code after receiving the startup code from the electronic communication device, and pushes at least one the message corresponding to the received startup code to the electronic communication device so that the message pushed by the hardware device is able to display on the operation interface of the application program of the electronic communication device.

The present invention further provides a method for pushing message, which is applied in a system of Internet of Things, the system of Internet of Things includes a remote server, at least one hardware device, and at least one electronic communication device, the remote server includes a database and a graphical program interface, the graphical program interface generates a plurality of startup codes corresponding to a subject name inputted into the graphical program interface, each of the hardware device is configured with one of the startup codes, and the electronic communication device includes an application program for operating the hardware device, steps of the method for pushing message comprising: establishing a connection between the electronic communication device and the hardware device via a way of short distance communication; uploading the startup code of the hardware device to the remote server by the application program of the electronic communication device when the hardware device is started for the first time; and determining the subject name corresponding to the startup code of the hardware device and pushing at least one message related to the determined subject name to the electronic communication device after the remote server receiving the startup code of the hardware device.

The present invention further provides a method for pushing message, which is applied in a system of Internet of Things, the system of Internet of Things includes at least one hardware device and at least one electronic communication device, the hardware device stores a firmware, and comprises a microcontroller and a first short distance communication module, and the electronic communication device includes an application program for operating the hardware device, steps of the method for pushing message comprising: configuring a plurality of startup codes and a plurality of corresponding messages into the firmware of the hardware device; establishing a connection between the electronic communication device and the hardware device via a way of short distance communication; inputting one of the startup codes into the operation interface of the application program of the electronic communication device and transmitting the inputted startup code to the hardware device; determining the message corresponding to the received startup code after the hardware device receiving the startup code from the electronic communication device; and pushing the message corresponding to the received startup code to the electronic communication device.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIG. 1 is a block diagram of a system of Internet of Things for pushing message according to an embodiment of the present invention.

FIG. 2 is a flow chart of a method of Internet of Things for pushing message according to an embodiment of the present invention.

FIG. 3 is a flow chart of a method of Internet of Things for pushing message according to another embodiment of the present invention.

FIG. 4 is a block diagram of a system of Internet of Things for pushing message according to another embodiment of the present invention.

FIG. 5 is a flow chart of a method of Internet of Things for pushing message according to another embodiment of the present invention.

### DETAILED DESCRIPTION OF THE PREFERRED EMBODIMENTS

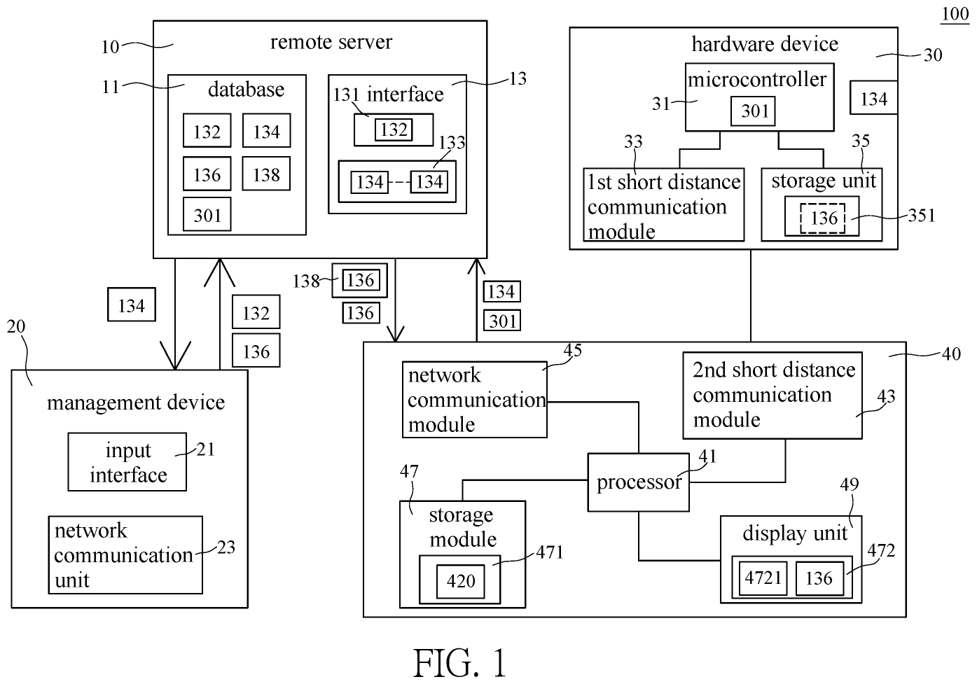

Please referring to FIG. 1, there is shown a block diagram of a system of Internet of Things for pushing message according to one embodiment of the present invention. As shown in FIG. 1, the system 100 of Internet of Things of the present embodiment includes a remote server 10, a management device 20, at least one hardware device 30, and at least one electronic communication device 40. The remote server 10 may be a network platform for pushing messages. The management device 20 and the electronic communication device 40 may be a mobile phone, a computer or an electronic device with network functions, and the hardware device 30 may be a self-photographing device, a smart home appliance, a Bluetooth speaker or other smart electronic device.

The remote server 10 includes a database 11 and a graphical program interface 13 that is connected to the database 11. The program interface 13 may be a program interface of a webpage or a software program, and may include a subject input box 131 and a startup code generator 133. The startup code generator 133 may be a random number generator or a serial number generator.

The management device 20 includes an input interface 21 and a network communication unit 23, and can be communicated with the remote server 10 by the network communication unit 23. The input interface 21 may be a keyboard or a touch screen. After the management device 20 logs in the remote server 10, the user of the management device 20 can input at least one subject name 132 into the subject input box 131 of the program interface 13 of the remote server 10 by the input interface 21, and input the number of the startup codes 134 to be generated into the startup code generator 133 of the program interface 13 of the remote server 10 by the input interface 21 so that the program interface 13 generates a plurality of startup codes 134 corresponding to the subject name 132. The remote server 10 transmits a plurality of startup codes 134, in a form of document, generated by the program interface 13 to the management device 20, and stores the subject name 132 and the startup code 134 corresponding to the subject name 132 in the database 11.

Each of the hardware devices 30 is configured with one of the startup codes 134, respectively, by the management device 20 after the management device 20 receives the startup codes 134 from the remote server 10. In one embodiment of the invention, the management device 20 may configure the startup code 134 into a firmware 351 of the hardware device 30 in a way of burning. In another embodiment of the present invention, the user of the management device 20 may print the startup code 134 on a paper, and then place the paper with the startup code 134 in the package of the hardware device 30 or paste the paper with the startup code 134 on an out surface of the hardware device 30. Thereafter, the user of the management device 20 is able to sell or give the hardware device 30 with the startup code 134 to the user of the electronic communication device 40.

The hardware device 30 includes a microcontroller 31, a first short distance communication module 33, and a storage unit 35. The microcontroller 31 is electrically connected to the first short distance communication module 33 and the storage unit 35. The storage unit 35 is used to store the firmware 351. The electronic communication device 40 includes a processor 41, a second short distance communication module 43, a network communication module 45, a storage module 47, and a display unit 49. The processor 41 is electrically connected to the second short distance communication module 43, the network communication module 45, the storage module 47 and the display unit 49.

An application program 471 is installed in the electronic communication device 40, and thus the electronic communication device 40 is able to operate the hardware device 30 by the application program 471. For example, the storage module 47 may be a flash memory for storing the application program 471. Before the user wants to control the operation of the hardware device 30 by the electronic communication device 40, firstly, the user may start the application program 471 installed in the electronic communication device 40 to display the operation interface 472 of the application program 471 on the display unit 49 of the electronic communication device 40. Then, the user of the electronic communication device 40 may touch or click a connection button 4721 of the operation interface 472 to perform a short distance wireless communication connection process 420 between the second short distance communication module 43 of the electronic communication device 40 and the first short distance communication module 33 of the hardware device 30. After the wireless communication connection process 420 is complete, the wireless connection between the electronic communication device 40 and the hardware device 30 will be established, so that the user of the electronic communication device 40 can control the operation of the hardware device 30 by the application program 471. In the present invention, the first short distance communication module 33 and the second short distance communication module 43 may be a Bluetooth communication module, a WiFi communication module, or an electronic element capable of communicating in a short distance.

Furthermore, the application program 471 of the electronic communication device 40 uploads the startup code 134 of the hardware device 30 to the remote server 10 when the hardware device 30 is started for the first time. In one embodiment of the present invention, the firmware 351 of the hardware device 30 is configured with the startup code 134, and the electronic communication device 40 can obtain the startup code 134 from the firmware 351 of the hardware device 30 through the application program 471, and then upload the startup code 134 to the remote server 10. In another embodiment of the present invention, the user may input the started code 134 of the hardware device 30 into the electronic communication device 40 by the keyboard or the touch screen, and then the electronic communication device 40 is able to upload the startup code 134 to the remote server 10. The remote server 10 executes a verification process of startup of the hardware device 30 after receiving the startup code 134 of the hardware device 30 from the electronic communication device 40. During the execution of the verification process of startup of the hardware device 30, the central controller of the remote server 10 is able to determine the subject name 132 corresponding to the startup code 134 of the hardware device 30, and then push at least one message 136 related to the determined subject name 132 to the electronic communication device 40. Thus, the message 136 pushed by the remote server 10 is display on the operation interface 472 of the application program 471 of the electronic communication device 40. For example, the message 136 may be a message of text format, sound format, or video format.

In one embodiment of the present invention, the user of the management device 20 may be a company, a business, a store or a merchant, the user of the electronic communication device 40 may be a consumer, and the hardware device 20 may be a commodity that is sold or given to the consumer by the company, the business, the store or the merchant. The user of the management device 20 can input the subject name 132, for example, a name of company, business, store, merchant, or brand, into the program interface 13 of the remote server 10, upload at least one advertising message 136 related to the name of company, business, store, merchant, or brand to the remote server 10, and then store the subject name 132 and/or the advertising message 136 into the database 11 of the remote server 10. When the hardware device 30 is started for the first time, the application program 417 of the electronic communication device 40 transmits the startup code 134 to the remote server 10. The remote server 10 determines the name of business, merchant or brand in the database 11 according to the received startup code 134 after receiving the startup code 134 of the hardware device 30 from the electronic communication device 40, extracts the advertisement message 136 related to the name of business, merchant or brand from the database 10, and then pushes the advertisement message 136 to the electronic communication device 40 so that the advertisement message 136 can be displayed on the operation interface 472 of the application program 471 of the electronic communication device 40. Thereby, while waiting for the execution of the verifying procedure of the hardware device 30, the user of the electronic communication device 40 can watch the advertisement message 136 pushed by the remote server 10 to achieve the purpose of marketing.

In another embodiment of the present invention, the user of the management device 20 may be a manager of a community, the user of the electronic communication device 40 may be a member of the community, and the hardware device 20 may be a gift that is given to the member by the community. The user of the management device 20 inputs the subject name 132, for example, a name of activity, into the program interface 13 of the remote server 10, uploads a notification message 136 related to the name of activity to the remote server 10, and then stores the name of activity and/or the notification message 136 into the database 11 of the remote server 10. When the hardware device 30 is started for the first time, the application program 417 of the electronic communication device 40 will transmit the startup code 134 to the remote server 10. The remote server 10 determines the name of activity in the database 11 according to the startup code 134 after receiving the startup code 134 of the hardware device 30 from the electronic communication device 40, extracts the notification message 136 related to the name of activity from the database 10, and then pushes the notification message 136 to the electronic communication device 40 so that the notification message 136 can be displayed on the operation interface 472 of the application 471 of the electronic communication device 40. Thereby, while waiting for the execution of the verifying procedure of the hardware device 30, the user of the electronic communication device 40 can watch the community notification pushed by the remote server 10 to achieve the purpose of the publicity of the activity.

In an embodiment of the invention, the hardware device 30 is configured with a unique identification code 301 that may be a physical address of the first short distance communication module 33, such as the MAC address of the Bluetooth communication module, the serial number of the hardware device 30 or an identification number written to the hardware device 30 by the manufacturer. When the hardware device 30 is started for the first time, the application program 471 of the electronic communication device 40 will transmit the startup code 134 and the unique identification code 301 of the hardware device 30 to the remote server 10. The remote server 10 records the unique identification code 301 of the hardware device 30, and maps the unique identification code 301 and the startup code 134 of the hardware device 30 to the same subject name 132. Whenever the application program 471 of the electronic communication device 40 executes a short distance wireless communication connection process 420 between the electronic communication device 40 and the hardware device 30, the electronic communication device 40 will transmit the unique identification code 301 of the hardware device 30 to the remote server 10, and then the remote server 10 determines the subject name 132 corresponding to the unique identification code 301 of the hardware device 30, and pushes the message 136 related to the determined subject name 132 to the electronic communication device 40 so that the message 136 pushed by the remote server 10 is able to display on the operation interface 472 of the application program 471 of the electronic communication device 40. Thereby, the user of the electronic communication device 40 can watch the advertisement or notification message 136 pushed by the remote server 10 before waiting for the wireless communication connection process between the electronic communication device 40 and the hardware device 30 to be completed.

In one embodiment of the present invention, the user of the management device 20 may configure at least one message 136, which wants to be pushed, in the firmware 351 of the hardware device 30 in advance before the hardware device 30 is given to the user of the electronic communication device 40. Therefore, when the electronic communication device 40 controls the operation of the hardware device 30 by the application program 471, the message 136 in the firmware 351 can be displayed on the operation interface 472 of the application program 471 of the electronic communication device 40.

In addition, in another embodiment of the present invention, the remote server 10 determines the subject name 132 corresponding to the startup code 134 of the hardware device 30 or the subject name 132 corresponding to the unique identification code 301 of the hardware device 30 after receiving the startup code 134 or the unique identification code 301 of the hardware device 30, selects at least one new message 136 related to the determined subject name 132, and configures the selected new message 136 into a firmware software 138. When the remote server 10 performs a firmware update process for the hardware device 30, it will transmit the firmware software 138 including the new message 136 to the electronic communication device 40. The application program 471 of the electronic communication device 40 updates the firmware 351 of the hardware device 351 by the firmware software 138, and configures the new message 136 included in the firmware software 138 into the firmware 351. Then, when the application program 471 of the electronic communication device 40 controls the operation of the hardware device 30 that has performed the firmware update, the new message 136 in the firmware 351 will be displayed on the operation interface 472 of the application program 471 of the electronic communication device 40. Thereby, the new advertisement or notification message 136 can be still pushed to the electronic communication device 40 via the hardware device 30 even if the electronic communication device 40 is disconnected from the remote server 10.

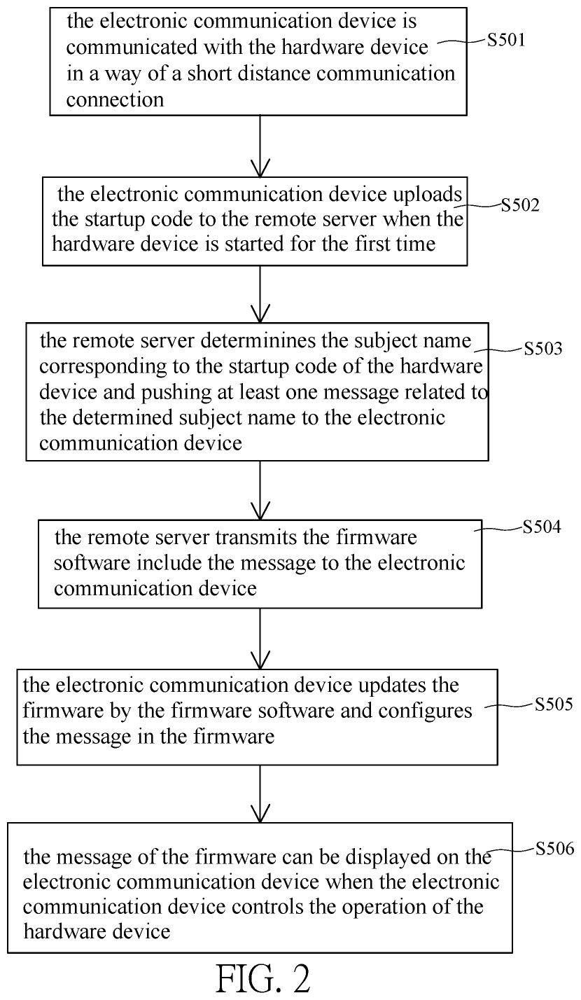

Please referring to FIG. 2, there is a flow chart of a method of Internet of Things for pushing message according to one embodiment of the present invention, and referring to FIG. 1 at the same time. As shown in FIG. 1 and FIG. 2, firstly, in step S501, the second short distance communication module 43 of the electronic communication device 40 is communicated with the first short distance communication module 33 of the hardware device 30 in a way short distance communication. In step S502, the application program 471 of the electronic communication device 40 will upload the startup code 134 of the hardware device 30 to the remote server 10 when the hardware device 30 is started for the first time, and the remote server 10 can perform a verification process of startup of the hardware device 30 after receiving the startup code 134 of the hardware device 30. In step S503, the remote server 10 determines the subject name 132 corresponding to the startup code 134 of the hardware device 30 during the execution of the verification process of startup of the hardware device 30, selects at least one message 136 related to the subject name 132, and then pushes the selected message 136 to the electronic communication device 40 such that the message 136 pushed by the remote server 10 may be displayed on the operation interface 472 of the application program 471 of the electronic communication device 40. Thereby, while waiting for the execution of the verifying procedure of the hardware device 30, the user of the electronic communication device 40 can watch the message 136 pushed by the remote server 10.

In step S504, after the verification process of startup of the hardware device 30 has completed, the remote server 10 may further perform a firmware update process for of the hardware device 30, configure the message 136 selected in step 503 into a firmware software 138, and then transmit the firmware software 138 including the message 136 to the electronic communication device 40. In step S505, the application program 471 of the electronic communication device 40 updates the firmware 351 of the hardware device 351 by the received firmware software 138, and configures the message 136 included in the firmware software 138 into the firmware 351. In step S506, the message 136 in the firmware 351 will be displayed on the operation interface 472 of the application 471 of the electronic communication device 40 when the application program 471 of the electronic communication device 40 controls the operation of the hardware device 30. Thereby, the advertisement or notification message 136 can be still pushed to the electronic communication device 40 via the hardware device 30 even if the electronic communication device 40 is disconnected from the remote server 10.

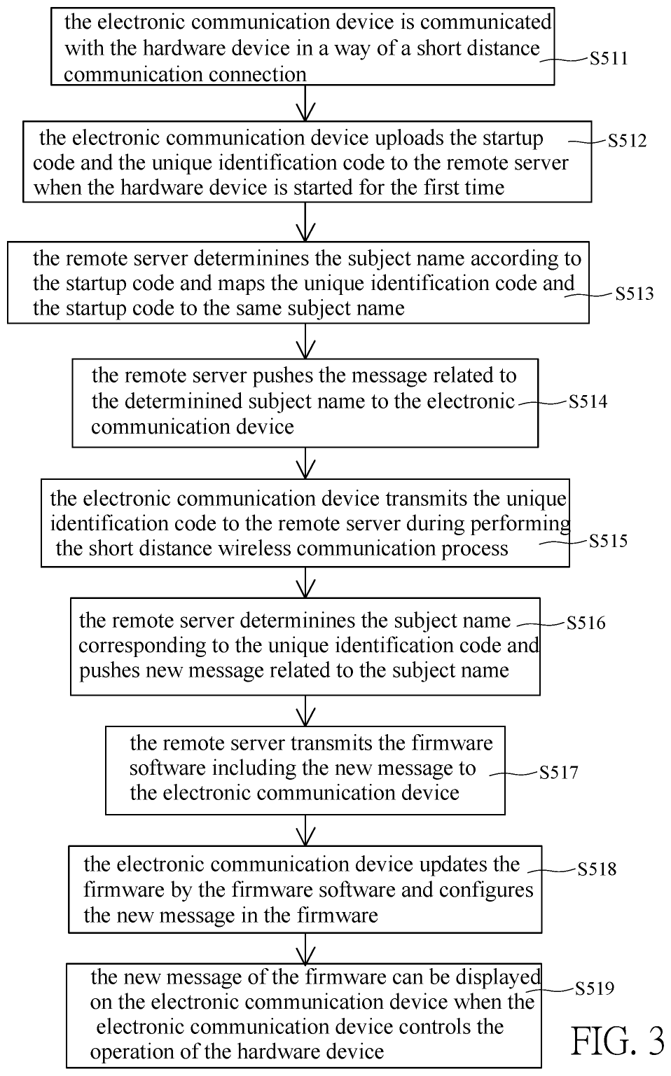

Please referring to FIG. 3, there is a flow chart of a method of Internet of Things for pushing message according to another embodiment of the present invention, and referring to FIG. 1 at the same time. As shown in FIG. 1 and FIG. 3, in step S511, the electronic communication device 40 is communicated with the hardware device 30 in the way short distance communication. Step S512, the application program 471 of the electronic communication device 40 uploads the startup code 134 and the unique identification code 301 of the hardware device 30 to the remote server 10 when the hardware device 30 is started for the first time, and then the remote server 10 will ready to perform the verifying process of startup of the hardware device 30 after receiving the startup code 134 and the unique identification code 301 of the hardware device 30. In step S513, the remote server 10 determines the subject name 132 corresponding to the startup code 134 of the hardware device 30 during the execution of the verification process of startup of the hardware device 30, and maps the unique identification code 301 and the startup code 134 of the hardware device 30 to the determined subject name 132. In step S514, the remote server 10 determines the subject name 132 corresponding to the startup code 134 or corresponding to the unique identification code 301, and then pushes the message 136 related to the subject name 132 to the electronic communication device 40 such that the message 136 pushed by the remote server 10 may be displayed on the operation interface 472 of the application program 471 of the electronic communication device 40. In step S515, whenever the application program 471 of the electronic communication device 40 performs a short distance wireless communication process 420 between the electronic communication device 40 and the hardware device 30, the electronic communication device 40 will transmit the unique identification code 301 of the hardware device 30 to the remote server 10. In step S516, the remote server 10 determines the subject name 132 corresponding to the received unique identification code 301 of the hardware device 30, and then pushes at least one new message 136 corresponding to the determined subject name 132 to the electronic communication device 40 so that the new message 136 pushed by the remote server 10 is able to be displayed on the operation interface 472 of the application program 471 of the electronic communication device 40. In step S517, the remote server 10 may further perform a firmware update process for the hardware device 30, configure the new message 136 selected in step S516 into the firmware software 138, and then transmit the firmware software 138 including the new message 136 to the electronic communication device 40. In step S518, the application program 471 of the electronic communication device 40 updates the firmware 351 of the hardware device 301 by the received firmware software 138, and configures the new message 136 included in the firmware software 138 into the firmware 351. In step S519, the new message 136 in the firmware 351 will be displayed on the operation interface 472 of the application program 471 of the electronic communication device 40 when the application program 471 of the electronic communication device 40 controls the operation of the hardware device 30.

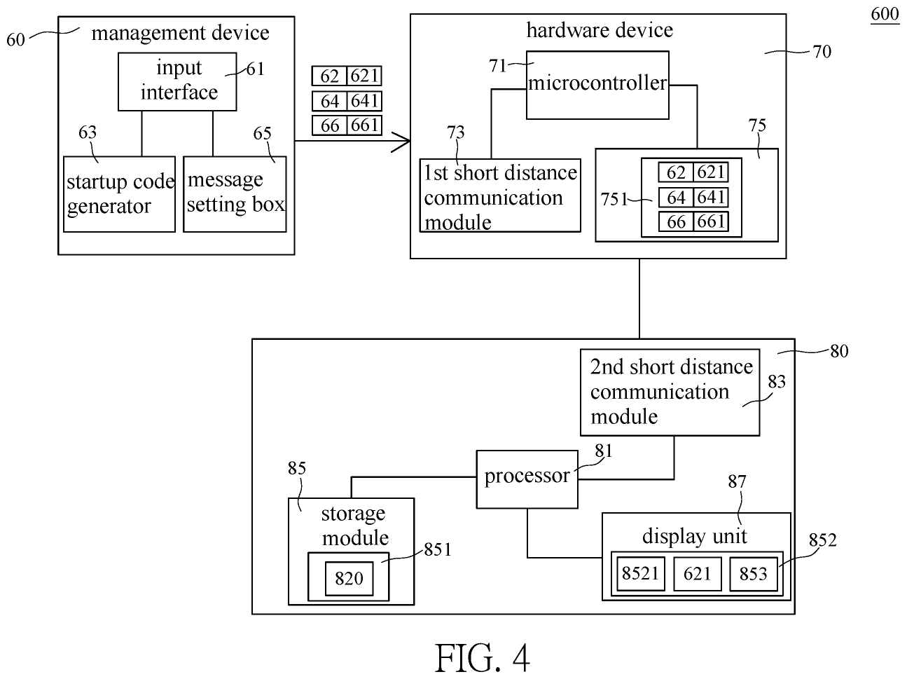

Please referring to FIG. 4, there is shown a block diagram of a system of Internet of Things for pushing message according to another embodiment of the present invention. The system 600 of Internet of Things of the present embodiment includes a management device 60, at least one hardware device 70, and at least one electronic communication device 80. The management device 60 and the electronic communication device 70 may be a mobile phone, a computer or an electronic device with a networking function, and the hardware device 80 may be a self-photographing device, a smart home appliance, a Bluetooth speaker or other intelligent electronic device.

The management device 60 includes an input interface 61, a startup code generator 63, and a message definition box 65. The startup code generator 63 and the message definition box 65 may be a program interface of web page or software. The user of the management device 60 can input the number of startup codes to be generated to the startup code generator 63 through the input interface 61 to obtain a plurality of startup codes 62 [symbol] 64 [symbol] 66. Each of messages 621/641/661 corresponding to each of startup codes 62/64/66 is defined through the message definition box 65, respectively. For example, a first type of message 621, a second type of message 641, and a third type of message 661 are inputted into the message definition box 65, respectively, and the first type of message 621 will be defined to correspond to the first startup code 62, the second type of message 641 will be defined to correspond to the second startup code 64, and a third type of message 661 will be defined to correspond to the third startup code 66.

The hardware device 70 includes a microcontroller 71, a first short distance communication module 73, and a storage unit 75. The microcontroller 71 is electrically connected to the first short distance communication module 73 and the storage unit 75. The storage element 75 stores a firmware 751. The user of the management device 60 can configure the startup codes 62/64/66 and the messages 621/641/661 corresponding to the startup codes 62/64/66 into the firmware 751 in a way of burning.

The electronic communication device 80 includes a processor 81, a second short distance communication module 83, a storage unit 85, and a display unit 87. The processor 81 is electrically connected to the second short distance communication module 83, the storage module 85, and the display unit 87.

In this embodiment, the hardware device 70 may be a gift or a commodity for a member. The manager or seller of the message push system 600 can provide different startup codes 62/64/66 for users of electronic communication device based on identities of users or the purpose of marketing. After the user of the electronic communication device 80 obtains the hardware device 70 having the startup code 62/64/66, an application program 851 is installed in the electronic communication device 80 for operating the hardware device 70. The application program 851 is stored in the storage module 85.

When the user wants to control the operation of the hardware device 70 by the electronic communication device 80, firstly, the application program 851 of the electronic communication device 80 is started, and then an operation interface 852 of the application program 851 is displayed on the display unit 87. The user of the electronic communication device 80 may touch or click a connection button 8521 of the operation interface 852 to perform a short distance wireless communication connection process 820 between the second short distance communication module 83 of the electronic communication device 80 and the first short distance communication module 73 of the hardware device 70. After the wireless communication connection process 820 is complete, the wireless connection between the electronic communication device 80 and the hardware device 70 will be established, and thus the user of the electronic communication device 80 can control the operation of the hardware device 70 by the application program 851. In the present invention, the first short distance communication module 73 and the second short distance communication module 83 may be a Bluetooth communication module, a WiFi communication module, or an electronic element capable of communicating in a short distance.

When the hardware device 70 is started for the first time, the microcontroller 71 of the hardware device 70 can perform a process for inputting startup code. For example, a startup code input box 853 is displayed in the operation interface 852 of the application program 851 of the electronic communication device 80, and the user of the electronic communication device 80 can input a startup code 62/64/66 into the startup code input box 853. Afterwards, when the user of the electronic communication device 80 controls the operation of the hardware device 70 via the application program 851, the microcontroller 71 of the hardware device 70 will push the corresponding message 621/641/661 to the electronic communication device 80 according to the startup code 62/64/66 inputted by the user of the electronic communication device 80 such that the message 621/641/661 pushed by the hardware device 70 can be displayed on the operation interface 852 of the application program 851 of the electronic communication device 80. For example, the user of the electronic communication device 80 may be a member of a merchant, the first type of message 621 may be an advertisement of the merchant, and the manager or seller of the system 600 may give the hardware device 70 and the first startup code 62 corresponding to the first type of message 621 to the user of the electronic communication device 80. When the hardware device 70 is started for the first time, the user of the electronic communication device 80 can input the first startup code 62 into the startup code input box 853 of the application program 851. Afterwards, when the user controls the operation of the hardware device 70 by the application program 851 of the electronic communication device 80, the hardware device 70 will push the first type of message 621 to the electronic communication device 80 according to the first startup code 62 inputted by the user of the electronic communication device 80, and the first type of message 621 will be displayed on the operation interface 852 of the application 851 of the electronic communication device 80.

As above embodiments, a plurality of messages 621/641/and 661 may be configured into the hardware device 70 in advance, and the user of the electronic communication device 80 inputs one of the startup codes 62, 64, and 66 into the electronic communication device 80 when the hardware device 70 is started for the first time. Thereafter, the hardware device 70 will push the message 621/641/661 to the electronic communication device 80 by the way of short distance communication connection according to the inputted startup code 62/64/66 when the application program 851 of the electronic communication device 80 controls the operation of the hardware device 70.

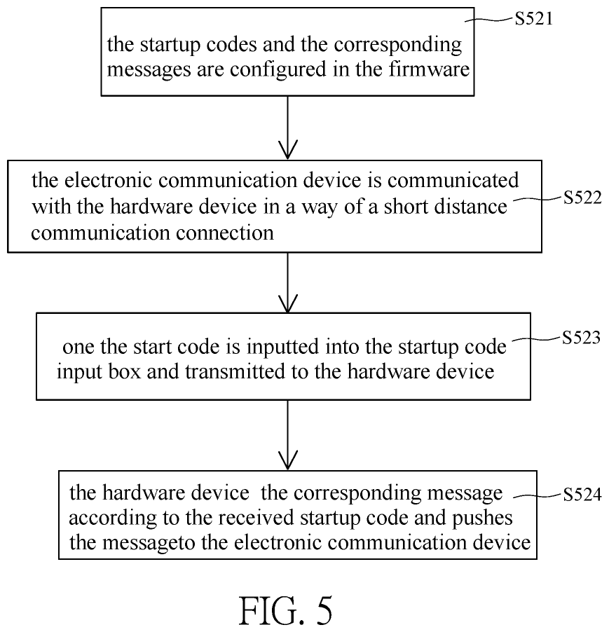

Please referring to FIG. 5, there is shown a flow chart of a method of Internet of Things for pushing message according to another embodiment of the present invention, and referring to FIG. 4 at the same time. As shown in FIG. 4 and FIG. 5, firstly, in step S521, a plurality of startup codes 62, 64, and 66 and the messages 621, 641, and 661 corresponding to the startup codes 62, 64, and 66 are configured into the firmware 751 of the hardware device 70. In step S522, the electronic communication device 80 is communication with the hardware device 70 via the way of short distance communication connection. In step S523, when the hardware device 70 is started for the first time, the startup code input box 853 is displayed on the operation interface 852 of the application 851, one of the startup codes 62, 64, and 66 is able to be inputted into the startup code input box 853 by the user of the electronic communication device 80, and therefore transmits to the hardware device 70. In step S524, the hardware device 70 determines the corresponding message 621/614/661 according to the received startup code 62/64/66, and pushes the determined message 621/641/661 to the electronic communication device 80 such that the message 621/641/661 can be displayed on the operation interface 852 of the application 851 of the electronic communication device 80.

The above disclosures are only the preferred embodiments of the present invention, and are not to be used to limit the scope of the present invention. All equivalent variations and modifications on the basis of shapes, structures, features and spirits described in claims of the present invention should be included in the claims of the present invention.

1. A system of Internet of Things for pushing message, comprising:
a remote server comprising a database and a graphical program interface, said database connected to said graphical program interface, wherein said graphical program interface comprises a subject input box and a startup code generator, the startup code generator generates a plurality of startup codes according to a subject name inputted into said subject input box, said subject name and said startup codes corresponding to said subject name are stored in said database;
at least one hardware device comprising a microcontroller and a first short distance communication module, wherein said microcontroller is electrically connected to said first short distance communication module, and each of said hardware devices is configured with one of said startup codes; and
at least one electronic communication device comprising a processor, a second short distance communication module, a network communication module, a storage module, and a display unit, wherein said processor is electrically connected to said second short distance communication module, said network communication module, said storage module, and said display unit, said storage module stores an application program for operating said hardware device, said electronic communication device communicates with said hardware device via said first short distance communication module and said second short distance communication module, and an operation interface of said application program is displayed on said display unit when said application program starts; wherein said application program of said electronic communication device uploads said startup code of said hardware device to said remote server when said hardware device is started for the first time, said remote server determines said subject name corresponding to said startup code of said hardware device after receiving said startup code of said hardware device, and pushes at least one message related to said determined subject name to said electronic communication device, so that said message pushed by said remote server is able to display on said operation interface of said application program of said electronic communication device.

2. The system according to claim 1, further comprises a management device having a function for connecting network, said management device is communicated with said remote server, and comprises an input interface; when said management device logs into said remote server, a user of said management device inputs said subject name into said subject input box of said graphical program interface by said input interface, and inputs the number of said startup codes to be generated into said startup code generator of said graphical program interface by said input interface so that the plurality of said startup codes corresponding to said subject name can be obtained by said management device, and then each of said hardware devices is configured with one of said startup codes by said management device.

3. The system according to claim 2, wherein said message related to said subject name is uploaded to said remote server by said management device, and stored s in said database of said remote server.

4. The system according to claim 1, wherein said subject name is a business name, a merchant name, a brand name or an event name.

5. The system according to claim 1, wherein said message is an advertisement message or a notification message.

6. The system according to claim 1, wherein said message is a message of text format, sound format or video format.

7. The system according to claim 1, wherein said hardware device comprises a firmware configured with said message, said message of said firmware is displayed on said operation interface of said application program of said electronic communication device when said electronic communication device controls the operation of said hardware device by said application program.

8. The system according to claim 7, wherein said remote server determines said subject name corresponding to said startup code of said hardware device after receiving said startup code of said hardware device, selects at least one said message related to said determined subject name, and configures said selected message into a firmware software; wherein said remote server transmits said firmware software including said message to said electronic communication device when said remote server wants to perform a firmware update process for said hardware device; said application program of said electronic communication device updates said firmware of said hardware device by said received firmware software, and configures said message included in said firmware software into said firmware; afterwards, said message in said firmware is displayed on said operation interface of said application program of said electronic communication device when said electronic communication device controls the operation of said hardware device.

9. The system according to claim 1, wherein said hardware device is further configured with a unique identification code, said application program of said electronic communication device uploads said startup code and said unique identification code of said hardware device to said remote server when said hardware device is started for the first time, said remote server records said unique identification code of said hardware device, and maps said startup code and said unique identification code of said hardware device to said same subject name; said electronic communication device transmits said unique identification code of said hardware device to said remote server whenever said application program of said electronic communication device executes a short distance wireless communication connection process between said electronic communication device and said hardware device, said remote server determines said subject name corresponding to said unique identification code of said hardware device, and pushes at least one said message related to said determined subject name to said electronic communication device so that said message pushed by said remote server is able to display on said operation interface of said application program of said electronic communication device.

10. The system according to claim 9, wherein said remote server determines said subject name corresponding to said unique identification code of said hardware device after receiving said unique identification code of said hardware device, selects at least one said message related to said determined subject name, and configures said selected message into a firmware software; wherein said remote server transmits said firmware software including said message to said electronic communication device when said remote server performs a firmware update process for said hardware device, said application program of said electronic communication device updates said firmware of said hardware device by said received firmware software, and configures said message included in said firmware software into said firmware; afterwards, said message in said firmware is displayed on said operation interface of said application program of said electronic communication device when said electronic communication device controls the operation of said hardware device.

11. A system of Internet of Things for pushing message, comprising:
at least one hardware device storing a firmware and comprising a microcontroller and a first short distance communication module, wherein said microcontroller is electrically connected to said first short distance communication module, a plurality of startup codes and a plurality of messages are defined in said firmware, and each of said startup code is corresponding to at least one said message; and
at least one electronic communication device comprising a processor, a second short distance communication module, a storage module, and a display unit, wherein said processor is electrically connected to said second short distance communication module, said storage module and said display unit, said storage module stores an application program for operating said hardware device, said electronic communication device communicates with said hardware device via said first short distance communication module and said second short distance communication module, and an operation interface of said application program is displayed on said display unit when said application program starts; wherein one of said startup codes is inputted into said operation interface of said application program of said electronic communication device, and is transmitted to said hardware device via said second short distance communication module and said first short distance communication module, said microcontroller of said hardware device determines said message corresponding to said received startup code after receiving said startup code from said electronic communication device, and pushes at least one said message corresponding to said received startup code to said electronic communication device so that said message pushed by said hardware device is able to display on said operation interface of said application program of said electronic communication device.

12. A method for pushing message, which is applied in a system of Internet of Things, said system of Internet of Things includes a remote server, at least one hardware device, and at least one electronic communication device, said remote server includes a database and a graphical program interface, said graphical program interface generates a plurality of startup codes corresponding to a subject name inputted into said graphical program interface, each of said hardware device is configured with one of said startup codes, and said electronic communication device includes an application program for operating said hardware device, steps of said method for pushing message comprising:
establishing a connection between said electronic communication device and said hardware device via a way of short distance communication;
uploading said startup code of said hardware device to said remote server by said application program of said electronic communication device when said hardware device is started for the first time; and
determining said subject name corresponding to said startup code of said hardware device and pushing at least one message related to said determined subject name to said electronic communication device after said remote server receiving said startup code of said hardware device.

13. The method according to claim 12, the steps of the method for pushing message further comprising:
determining said subject name corresponding to said startup code of said hardware device and selecting at least one message related to said determined subject name after said remote server receiving said startup code of said hardware device;
configuring said selected message into firmware software by said remote server;
transmitting said firmware software including said message to said electronic communication device by said remote server when said remote server wants to perform a firmware update process for said hardware device;
updating a firmware of said hardware device by said firmware software and configuring said message included in said firmware software into said firmware by said electronic communication device; and
displaying said message of said firmware when said electronic communication device controls to the operation of said hardware device.

14. The method according to claim 12, wherein said hardware device comprises a unique identification code, the steps of the method for pushing message further comprising:
uploading said startup code and said unique identification code of said hardware device to said remote server by said application program of said electronic communication device when said hardware device is started for the first time;
mapping said unique identification code and said startup code of said hardware device to said same subject name by said remote server;
transmitting said unique identification code of said hardware device to said remote server by said electronic communication device whenever said application program of said electronic communication device performs a short distance wireless communication connection process between the electronic communication device and the hardware device; and
determining said subject name corresponding to said unique identification code of said hardware device and pushing at least one said message related to said determined subject name to said electronic communication device after said remote server receiving said unique identification code of said hardware device.

15. The method according to claim 14, the steps of the method for pushing message further comprising:
determining said subject name corresponding to said unique identification code of said hardware device and selecting at least one message related to said determined subject name after said remote server receiving said unique identification code of said hardware device;
configuring said selected message into a firmware software by said remote server;
transmitting said firmware software including said message to said the electronic communication device by said remote server when said remote server wants to perform a firmware update process for said hardware device;
updating a firmware of said hardware device by said firmware software and configuring said message included in said firmware software into said firmware by said electronic communication device; and
displaying said message of said firmware when said electronic communication device controls the operation of said hardware device.

16. A method for pushing message, which is applied in a system of Internet of Things, said system of Internet of Things includes at least one hardware device and at least one electronic communication device, said hardware device stores a firmware, and comprises a microcontroller and a first short distance communication module, and said electronic communication device includes an application program for operating said hardware device, steps of said method for pushing message comprising:
configuring a plurality of startup codes and a plurality of corresponding messages into said firmware of said hardware device;
establishing a connection between said electronic communication device and said hardware device via a way of short distance communication;
inputting one of said startup codes into said operation interface of said application program of said electronic communication device and transmitting said inputted startup code to said hardware device;
determining said message corresponding to said received startup code after said hardware device receiving said startup code from said electronic communication device; and
pushing said message corresponding to said received startup code to said electronic communication device.
